(19) United States
(12) Patent Application Publication
(10) Pub. No.: US 2014/0179295 A1
(43) Pub. Date: Jun. 26, 2014

(54) DERIVING ENVIRONMENTAL CONTEXT AND ACTIONS FROM AD-HOC STATE BROADCAST

(71) Applicants: Enno Luebbers, Munich (DE); Thorsten Meyer, Regensburg (DE); Mikhail Lyakh, St. Petersburg (RU); Ray Kinsella, Shannon (IE)

(72) Inventors: Enno Luebbers, Munich (DE); Thorsten Meyer, Regensburg (DE); Mikhail Lyakh, St. Petersburg (RU); Ray Kinsella, Shannon (IE)

(21) Appl. No.: 13/721,777

(22) Filed: Dec. 20, 2012

(51) Int. Cl. H04W 4/00

(52) U.S. Cl. CPC H04W 4/001
USPC 455/418

(57) ABSTRACT

Context state decisions of other users, based on the state of their mobile devices in the vicinity, are used to determine if it reasonable to have your device make or suggest a similar state change. By broadcasting state changes or identifiable actions to all other devices in the vicinity using short-range communications, devices can anonymously notify others in their vicinity of actions they or their users have taken. By collecting and analyzing these notifications, devices can then build their own understanding of the current context and autonomously decide on appropriate actions to take for themselves.

### FIELD OF THE INVENTION

Embodiments of the present invention are directed to mobile devices and, more particularly, to deriving contexts from nearby mobile devices to change a current state of other mobile devices.

### BACKGROUND INFORMATION

In many cases, actions performed on mobile devices (such as setting operational modes) require explicit user interaction, although the action to be performed could in principle be deduced from the device's context.

For example, usually everybody attending a conference, cultural event, or in a theater, etc. manually sets their phone to “mute”. This needs to be done explicitly, because the phone has no way of knowing by itself that it would be appropriate not to ring. Inevitably several phones will ring and disrupt the event despite a prior announcement or signs informing people to mute their phones.

Deriving the current context and appropriate actions is a difficult challenge for mobile devices, as every “kind” of context exhibits different properties that cannot be uniformly or cheaply measured. In many cases, the kinds of contexts a device is expected to react upon may not even be known at design time, but be defined by later software additions (i.e. apps).

One approach that is used to automatically set device modes based on its environment may use complex sensors and sophisticated data processing to accurately deduce the current context from sensor data. For example, to determine a suitable recording mode for a digital camera, complex scene analysis algorithms are used to “guess” the nature of the scene. However, this requires that the device has the right set of sensors and sufficient processing capabilities to deduce the specific context and automatically invoke appropriate actions.

In the case of phone muting it has been suggested to use GPS or other location data to determine when a phone is in an area where it should be mute. However, these solutions may be lacking since it may not always be necessary to mute in a certain location.

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1 is a block diagram illustrating a mobile device according to one embodiment;

FIG. 2 is a diagram showing a mobile device engaged in an ad hoc network of nearby mobile devices communicating state changes to one another;

FIG. 3 is a diagram illustrating a mobile device taking action to change state based on state changes of other nearby mobile devices;

FIG. 4 is a diagram showing a camera (could be a camera integrated into another mobile device such as a phone), in an ad hoc network with nearby cameras sharing context information;

FIG. 5 is a diagram illustrating cars each having a device involved in an ad hoc network communicating state or context data to each other;

FIG. 6 shows a table for tracking various state changes and modes of various devices on the network; and

FIG. 7 is a flow diagram illustrating a flow of events according to one embodiment.

### DETAILED DESCRIPTION

Described is a scheme to record context state decisions of other users, based on the state of the mobile devices in the vicinity and, determine if it reasonable to have your device make or suggest a similar state change. By broadcasting state changes or identifiable actions to all other devices in the vicinity using short-range communications, devices can anonymously notify others in their vicinity of actions they or their users have taken. By collecting and analyzing these notifications, devices can then build their own understanding of the current context and autonomously decide on appropriate actions to take for themselves.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

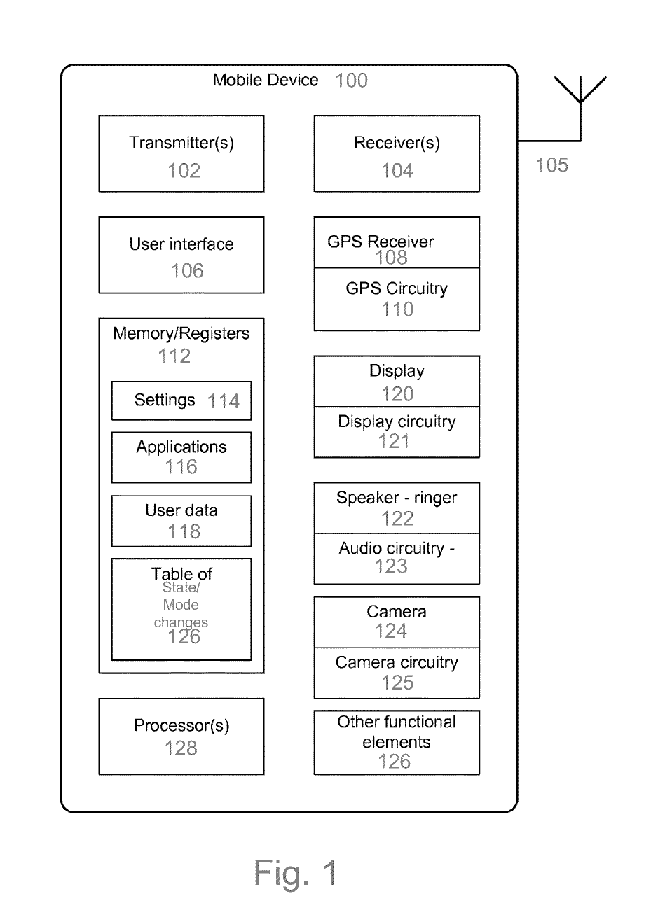

FIG. 1 illustrates an embodiment of a mobile device or system. The mobile device may comprise a phone, a cell phone, a smart phone, a tablet, or any other device which, among other things, is capable of wirelessly communicating with other nearby devices. In some embodiments, a mobile device 100 includes one or more transmitters 102 and receivers 104 for transmitting and receiving data. In some embodiments, the mobile device includes one or more antennas 105 for the transmission and reception of data, where the antennas may include dipole, monopole antennas, patch antennas, etc. The mobile device 100 may further include a user interface 106, including, but not limited to, a graphical user interface (GUI) or traditional keys. The mobile device 100 may further include one or more elements for the determination of physical location or velocity of motion, including, but limited to, a GPS receiver 108 and GPS circuitry 110.

The mobile device 100 may further include one or more memories or sets of registers 112, which may include non-volatile memory, such as flash memory, and other types of memory. The memory or registers 112 may include one more groups of settings for the device 114, including default settings, user-set settings established by user of the mobile device, and enterprise-set settings established by an enterprise, such as an employer, who is responsible for IT (information technology) support. The memory 112 may further include one or more applications 116, including applications that support or control operations to send or receive state change or current mode information according to embodiments. The memory 112 may further include user data 118, including data that may affect limitations of functionality of the mobile device and interpretations of the circumstances of use of the mobile device. For example, the user data 118 may include calendar data, contact data, address book data, pictures and video files, etc.

The mobile device 100 may include various elements that are related to the functions of the system. For example, the mobile device may include a display 120 and display circuitry 121; a microphone and speaker 122 and audio circuitry 123 including audible signaling e.g., ringers); a camera 124 and camera circuitry 125; and other functional elements such as a table state changes or modes of nearby devices 126, according to one embodiment. The mobile device may further include one or more processors 128 to execute instructions, to control the various functional modules of the device.

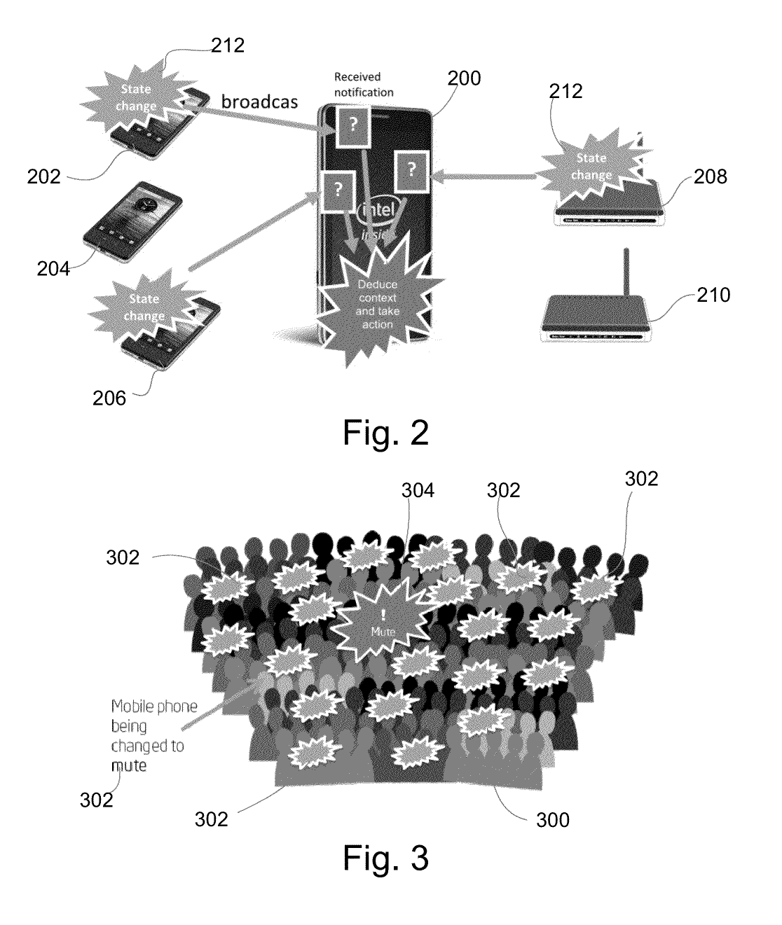

Referring now to FIG. 2, there is shown a mobile device 200, such as that shown in FIG. 1. The device may be a tablet, a mobile phone, a smart phone, a laptop, a mobile internet device (MID), camera, or the like. It may be surrounded by nearby similar devices 202, 204, 206. It may also be in wireless distance of routers, WiFi, or other types of wireless devices 208 and 210. Each of the devices 200, 202, 204, 206, 208, and 210, may broadcast state change information 212 which may be received by all other devices 200, 202, 204, 206, 208, and 210 forming an ad hoc network. The nearby range may be determined, for example by GPS, by signal strength, or simply by the limitations of near range communication technologies employed by the devices.

According to embodiments, the mobile device 200 may record decisions other users via devices 202, 204, 206, 208, and 210 in the vicinity have taken, and use this information to deduce an appropriate context that may be also taken by device 200. By broadcasting state changes 212 or identifiable actions to all other devices in the vicinity using short-range communications, devices can anonymously notify others in their vicinity of actions they or their users have taken (e.g. mute phone), possibly in response to a specific context (e.g. a conference presentation about to start and phones should be muted). By collecting and analyzing these notifications, devices can then build their own understanding of the current context and autonomously decide on appropriate actions to take for themselves.

Useable information are, for example, user actions performed on mobile devices (mode/state changes), or events detected by infrastructure components (e.g. device log-on, device shut down, etc.).

Referring to FIG. 3, there is shown an example of a crowd of people, many of which have mobile devices such as shown in FIG. 2. The people 300 may be gathered for some event, a conference, a house of worship, a movie theater, etc. Many of the devices may broadcast state change information that may be received by any other of the devices nearby, thus forming an ad hoc network of devices. If, for example, within some time period, say five minutes, twenty mobile phones 302 in the vicinity change their state to “mute” or “vibrate only”, then it probably is a good idea for my own phone 304 to mute as well. Depending on a mode set my phone 304, it may automatically mute if the appropriate number of nearby phones go mute in the given time frame or perhaps vibrate and remind the user of phone 304 to mute. Similarly, if a number of devices in the vicinity broadcast that they are about to go into airplane mode, then there is a good probability that the devices are in an airplane and all devices should do the same and power down.

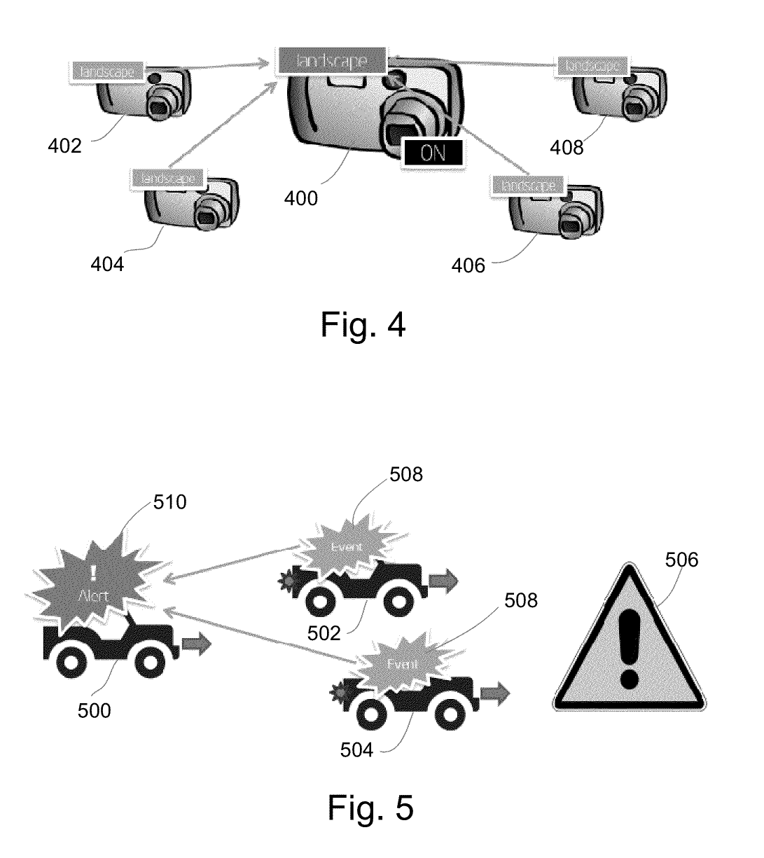

Referring now to FIG. 4, there is shown a plurality of cameras 402, 404, 406, and 408. For example, a group of people may all be at a same event or attraction where many people are photographing a same scene. While the cameras are shown as stand-alone cameras, they may also be integrated into other devices and comprise many of the same components described with reference to FIG. 1. The cameras may be capable of different settings or photography modes, such as landscape or portrait mode, flash or no flash, “sport”, “night” “outdoor”, etc. If most cameras 402-408 in the vicinity are using the ‘landscape’ mode to take pictures, according to embodiments, this information would be available to my camera 400 and my camera 400 may offer this as a suggested mode on power-up or perhaps automatically set my camera 400 to landscape mode. Similarly, there are many venues where flash photography is not allowed. If a threshold number of nearby cameras/mobile devices 402-408 transmit state information indicating that their flash has been disabled, then my device 400 may also disable its flash or at least offer a warning to consider manually disabling the flash prior to taking a picture.

Referring now to FIG. 5, embodiments may also be useful for traffic situations. As shown, a car 500 may be traveling along a road or highway with other cars ahead 502 and 504. Each car may have a passenger with one or more mobile devices onboard or perhaps the cars are equipped with in in-vehicle infotainment (IVI) system, capable of wireless communication similar to the mobile device shown in FIG. 1. If the cars ahead 502 and 504, going in my direction, suddenly decelerate or stop due to a traffic event 506, the cars 502 and 504 may broadcast the event 508 to be received by the mobile device of car 500. Thus, the mobile device of car 500 may be able to display or sound a warning to the driver of car 500 warning of a traffic event ahead.

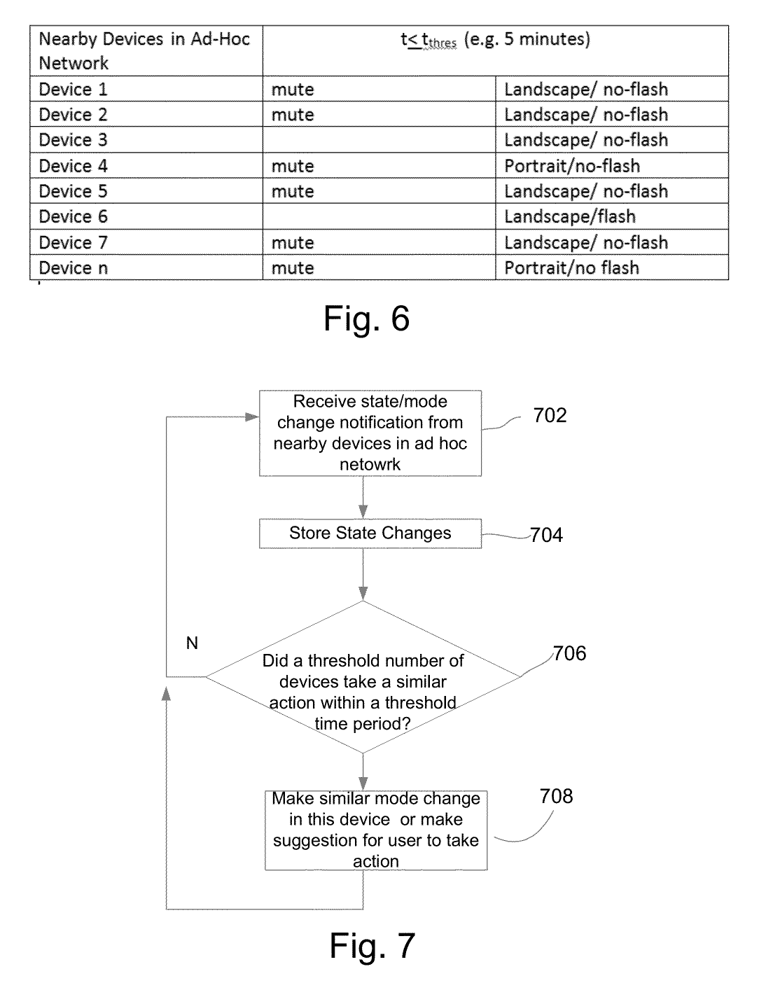

Referring now to FIG. 6, there is shown a table which, for example, may be stored in memory table module 126, as shown in FIG. 1 for tracking state or mode changes of nearby devices. As shown, state information may be received from nearby devices that form an ad hoc network. The network may be established by any means, such as for example WiFi direct, Bluetooth, etc. and may use some open data exchange formats such as, for example, JSON, XML, or the like. The network may be open access where anyone can send and anyone can listen. In this example, there are N nearby devices shown labeled Device 1 to Device N. The table may be dynamic in that devices may come and devices may go, and devices currently on the network my periodically broadcast a change in state information. In the example shown, six devices have turned mute within the previous threshold period (in this case the last 5 minutes). If a predetermined number of devices to take a particular action during the threshold period is met, then perhaps this device should also take the same action; in this case go mute or alert the user that they should manually set the device on mute. Of course the threshold number of devices and the threshold time period here are by way of example only as different thresholds may be selected for different circumstances.

Likewise, camera modes of nearby cameras may be monitored as shown in the Example in FIG. 6. If a majority or threshold number of nearby camera devices have switched to landscape mode with no flash, then my camera may offer this as a suggested mode on power-up or perhaps automatically set my camera 400 to landscape and no flash mode.

Referring now to FIG. 7, there is shown a flow diagram illustrating the basic flow of one embodiment. In block 702 an ad hoc network may be established with nearby wireless devices broadcasting state or state change information. The broadcasts may be received by a particular device and the information pertaining to the state changes stored in block 704. In block 706, if a threshold number of devices in the network take a similar action within a preset threshold time period, then in block 708, the present device should automatically make a similar mode change or alert the user that perhaps this change should be made manually.

This approach has the distinct advantage to be uniformly applicable to all kinds of contexts, as their detection is done purely by analyzing notifications received via a communication link, and not dependent on the presence of a specific sensor. The definition of contexts and notifications can be done purely in software, and can be changed over the lifetime of the device (e.g, based on installed applications etc.). Such an approach also may require far less computational complexity than the analysis of complex and real-time sensor data, thus saving energy and extending battery life.

Also, this method uses the distributed intelligence of other users instead of relying on hardcoded context detection algorithms. That is, it could be considered an application of “crowd sourcing”, as the actual “detection events” used for deriving the context are collected from other devices/users; though an important distinction to existing applications is that relevant data is only collected in the device's vicinity. Generally speaking, that more data points (more generated events and notifications) may improve the quality and reliability of the context derivation process. Given that the confidence in the derived context is high enough, an appropriate response might be to simply take the exact same action indicated by the received notifications (i.e., in the example if many nearby phones going mute, simply mute this phone as well).

In one example, at least one machine readable storage medium comprises a set of instructions which, when executed by a processor, cause a first mobile device to receive mode information from a plurality of other mobile devices, store the mode information in a memory, and determine from the mode information if the first mobile device should change mode.

In another example the mode information comprises a change of mode.

In another example, the first mobile device comprises a mobile phone and wherein the mode information comprises ones of the plurality of other devices changing to a mute mode.

In another example, first mobile device comprises a mobile camera and wherein the mode information comprises ones of the plurality of other devices changing to a particular photography mode.

In another example, the photography mode comprises landscape mode or portrait mode.

In another example, the photography mode comprises flash or no flash.

In another example, the first mobile device is associated with a vehicle and the mode information comprises sensed deceleration.

In another example, a method for changing a mode of a first mobile device, comprises: receiving mode information from a plurality of other mobile devices, storing the mode information, analyzing the mode information to determine if a threshold number of the plurality of other mobile devices have entered a same mode within a threshold time period, and determining from the analysis if the first mobile device should change to the same mode.

In another example the first mobile device comprises a mobile phone and wherein the mode information comprises ones of the plurality of other mobile devices changing to a mute mode.

In another example, the first mobile device comprises a mobile camera and wherein the mode information comprises ones of the plurality of other mobile devices changing to a particular photography mode.

In another example the photography mode comprises landscape mode or portrait mode.

In another example, the photography mode comprises flash or no flash.

In another example, the first mobile device is associated with a vehicle and wherein the mode information comprises sensed deceleration.

In another example, a mobile device comprises a plurality of mode settings, a receiver to receive mode information from other mobile devices, a memory to store the mode information, a processor to analyze the mode information to change the mode of the mobile device based on the mode information from the other mobile devices.

In another example, the mobile device comprises a mobile phone and the mode information comprises a plurality of the other mobile devices in mute mode.

In another example, the mobile device comprises a mobile camera and wherein the mode information comprises a plurality of the other mobile devices changing to a particular photography mode.

In another example, the photography mode comprises landscape mode or portrait mode.

In another example the photography mode comprises flash or no flash.

In another example the mobile device comprises an in vehicle infotainment (IVI) system and the wherein the mode information comprises sensed deceleration.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. At least one machine readable storage medium comprising a set of instructions which, when executed by a processor, cause a first mobile device to:
receive mode information from a plurality of other mobile devices;
store the mode information in a memory; and
determine from the mode information if the first mobile device should change mode.

2. The at least one machine readable storage medium as recited in claim 1 wherein the mode information comprises a change of mode.

3. The at least one machine readable storage medium as recited in claim 2 wherein the first mobile device comprises a mobile phone and wherein the mode information comprises ones of the plurality of other devices changing to a mute mode.

4. The at least one machine readable storage medium as recited in claim 1 wherein the first mobile device comprises a mobile camera and wherein the mode information comprises ones of the plurality of other devices changing to a particular photography mode.

5. The at least one machine readable storage medium as recited in claim 4 wherein the photography mode comprises landscape mode or portrait mode.

6. The at least one machine readable storage medium as recited in claim 4 wherein the photography mode comprises flash or no flash.

7. The at least one machine readable storage medium as recited in claim 1 wherein the first mobile device is associated with a vehicle and wherein the mode information comprises sensed deceleration.

8. A method for changing a mode of a first mobile device, comprising:
receiving mode information from a plurality of other mobile devices;
storing the mode information;
analyzing the mode information to determine if a threshold number of the plurality of other mobile devices have entered a same mode within a threshold time period; and
determining from the analysis if the first mobile device should change to the same mode.

9. The method as recited in claim 8 wherein first mobile device comprises a mobile phone and wherein the mode information comprises ones of the plurality of other mobile devices changing to a mute mode.

10. The method as recited in claim 8 wherein the first mobile device comprises a mobile camera and wherein the mode information comprises ones of the plurality of other mobile devices changing to a particular photography mode.

11. The method as recited in claim 10 wherein the photography mode comprises landscape mode or portrait mode.

12. The method as recited in claim 10 wherein the photography mode comprises flash or no flash.

13. The method as recited in claim 10 wherein the first mobile device is associated with a vehicle and wherein the mode information comprises sensed deceleration.

14. A mobile device, comprising:
a plurality of mode settings;
a receiver to receive mode information from other mobile devices;
a memory to store the mode information;
a processor to analyze the mode information to change the mode of the mobile device based on the mode information from the other mobile devices.

15. The mobile device as recited in claim 14 wherein the mobile device comprises a mobile phone and the mode information comprises a plurality of the other mobile devices in mute mode.

16. The mobile device as recited in claim 14 wherein the mobile device comprises a mobile camera and wherein the mode information comprises a plurality of the other mobile devices changing to a particular photography mode.

17. The mobile device as recited in claim 16 wherein the photography mode comprises landscape mode or portrait mode.

18. The mobile device as recited in claim 16 wherein the photography mode comprises flash or no flash.

19. The mobile device as recited in claim 14 wherein the mobile device comprises an in vehicle infotainment (IVI) system and the wherein the mode information comprises sensed deceleration.
